(19) United States
(12) Patent Application Publication
(10) Pub. No.: US 2016/0314442 A1
(43) Pub. Date: Oct. 27, 2016

(54) NUMERICAL VALUE TRANSFER METHOD, TERMINAL, CLOUD SERVER AND STORAGE MEDIUM

(71) Applicant: Xiaomi Inc., Beijing (CN)

(72) Inventors: Lifeng JIANG, Beijing (CN); Bo JIANG, Beijing (CN); Feng LI, Beijing (CN)

(73) Assignee: Xiaomi Inc., Beijing (CN)

(21) Appl. No.: 15/082,062

(22) Filed: Mar. 28, 2016

(30) Foreign Application Priority Data
Apr. 21, 2015 (CN) 201510189000.5

(51) Int. Cl. G06Q 20/10; G06Q 20/24; G06Q 40/02

(52) U.S. Cl. CPC G06Q 20/10; G06Q 40/025; G06Q 20/24

(57) ABSTRACT

This disclosure relates to a monetary value transfer method. The method comprises receiving a monetary value transfer request sent by a terminal, the monetary value transfer request including user characteristic information, a user account being used on the terminal and a target transfer amount, the user characteristic information being extracted from a target image stored in the terminal, acquiring credit information and historical monetary value transfer record of a user based on the user characteristic information and the user account, and processing monetary value transfer based on the credit information, the historical monetary value transfer record and the target transfer amount.

This application claims the priority of the Chinese Patent Application No. 201510189000.5 filed on Apr. 21, 2015, which is incorporated herein by reference in its entirety.

### TECHNICAL FIELD

The present disclosure generally relates to the field of Internet, and more particularly, relates to a numerical value transfer method, a terminal, a cloud server and a storage medium.

### BACKGROUND

Since smart TVs have fully open platforms and are equipped with operating systems, a user can install or uninstall applications by oneself. Therefore, the smart TVs are becoming more popular and gradually replacing the traditional TVs. In addition, with the popularity of network transaction, the methods of network transaction performed through smart TVs are gaining more attention. At the present time, in the related arts, when performing network transaction through smart TVs, numerical value transfer of virtual or real currency is usually involved to some extent. When performing numerical value transfer, a user usually needs to manually input his or her account number and account password for the numerical value transfer to a smart TV so as to complete the numerical value transfer.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

To overcome the above problems in the related arts, the present disclosure provides a numerical value transfer method, a terminal, a cloud server and a storage medium.

According to a first aspect of embodiments of the present disclosure, there is provided a numerical value transfer method, including receiving a numerical value transfer request sent by a terminal, the numerical value transfer request carrying user characteristic information, a user account being currently used on the terminal and a transfer amount, the user characteristic information being extracted from a target image in the terminal, acquiring credit information and historical numerical value transfer record of a user based on the user characteristic information and the user account, and performing numerical value transfer based on the credit information, the historical numerical value transfer record and the transfer amount.

According to a second aspect of the embodiments of the present disclosure, there is provided a numerical value transfer method, including when a numerical value transfer instruction is received, performing image collection on a user currently using a terminal to obtain a target image, extracting user characteristic information from the target image, and sending a numerical value transfer request to a cloud server so that the cloud server performs numerical value transfer based on the numerical value transfer request, the numerical value transfer request carrying the user characteristic information, a user account being currently used on the terminal and a transfer amount.

According to a third aspect of the embodiments of the present disclosure, there is provided a cloud server, the cloud server includes a receiving module configured to receive a numerical value transfer request sent by a terminal, the numerical value transfer request carrying user characteristic information, a user account being currently used on the terminal and a transfer amount, the user characteristic information being obtained by characteristic extraction from a target image in the terminal, an acquiring module configured to acquire credit information and historical numerical value transfer record of a user based on the user characteristic information and the user account, and a numerical value transfer module configured to perform numerical value transfer based on the credit information, the historical numerical value transfer record and the transfer amount.

According to a fourth aspect of the embodiments of the present disclosure, there is provided a terminal, the terminal includes an image collecting module configured to, when a numerical value transfer instruction is received, perform image collection on a user currently using the terminal to obtain a target image, an extracting module configured to extract user characteristic information from the target image, and a first sending module configured to send a numerical value transfer request to a cloud server so that the cloud server performs numerical value transfer based on the numerical value transfer request, the numerical value transfer request carrying the user characteristic information, a user account being currently used on the terminal and a transfer amount.

According to a fifth aspect of the embodiments of the present disclosure, there is provided a cloud server, the cloud server includes a processor, and a memory configured to store an instruction executable by the processor. The processor is configured to receive a numerical value transfer request sent by a terminal, the numerical value transfer request carrying user characteristic information, a user account being currently used on the terminal and a transfer amount, the user characteristic information being obtained by characteristic extraction from a target image in the terminal, acquire credit information and historical numerical value transfer record of a user based on the user characteristic information and the user account, and perform numerical value transfer based on the credit information, the historical numerical value transfer record and the transfer amount.

According to a sixth aspect of the embodiments of the present disclosure, there is provided a terminal, the terminal includes a processor, and a memory configured to store an instruction executable by the processor. The processor is configured to when a numerical value transfer instruction is received, perform image collection to a user currently using the terminal to obtain a target image, extract user characteristic information from the target image, and send a numerical value transfer request to a cloud server so that the cloud server performs numerical value transfer based on the numerical value transfer request, the numerical value transfer request carrying the user characteristic information, a user account being currently used on the terminal and a transfer amount.

According to a seventh aspect of the embodiments of the present disclosure, there is provided a non-transitory computer-readable storage medium having stored therein instructions that, when executed by a processor of a cloud server, causes the cloud server to perform a numerical value transfer method, the method including receiving a numerical value transfer request sent by a terminal, the numerical value transfer request carrying user characteristic information, a user account being currently used on the terminal and a transfer amount, the user characteristic information being extracted from a target image in the terminal, acquiring credit information and historical numerical value transfer record of a user based on the user characteristic information and the user account, and performing numerical value transfer based on the credit information, the historical numerical value transfer record and the transfer amount.

According to an eighth aspect of the embodiments of the present disclosure, there is provided a non-transitory computer-readable storage medium having stored therein instructions that, when executed by a processor of a terminal, causes the terminal to perform a numerical value transfer method, the method including obtaining an image of a user currently using the terminal when a monetary value transfer instruction is received, extracting user characteristic information from the image of the user, and sending a monetary value transfer request to a cloud server, the monetary value transfer request including the user characteristic information, a user account being used on the terminal and a transfer amount.

It should be understood that both the foregoing general description and the following detailed description are only exemplary and explanatory and are not restrictive of the invention.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart showing a numerical value transfer method according to an exemplary embodiment.

FIG. 2 is a flow chart showing a numerical value transfer method according to an exemplary embodiment.

FIG. 3 is a flow chart showing a numerical value transfer method according to an exemplary embodiment.

FIG. 4 is a block diagram of a cloud server according to an exemplary embodiment.

FIG. 5 is a block diagram of a numerical value transfer module according to an exemplary embodiment.

FIG. 6 is a block diagram of a terminal according to an exemplary embodiment.

FIG. 7 is a block diagram of a terminal according to an exemplary embodiment.

FIG. 8 is a block diagram of a cloud server according to an exemplary embodiment.

FIG. 9 is a block diagram of a terminal according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

The technical solutions of the embodiments of this disclosure have the following advantageous effects. In the embodiments of this disclosure, when the terminal receives a numerical value transfer instruction, image collection is performed on the user currently using the terminal to obtain a target image, and by extracting the user characteristic information of the target image, it saves the user from manually inputting account number and password for performing numerical value transfer with easy operations and enhances the security for numerical value transfer. Moreover, since the cloud server performs numerical value transfer by acquiring credit information and historical numerical value transfer record of the user, the security for numerical value transfer is further improved.

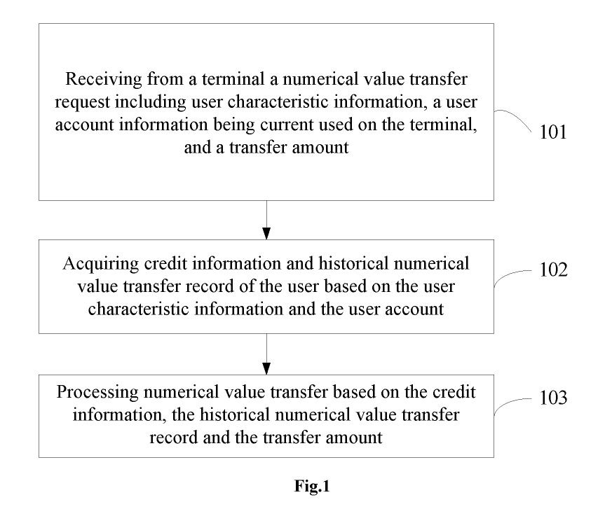

FIG. 1 is a flow chart showing a numerical value transfer method according to an exemplary embodiment. As shown in FIG. 1, the numerical value transfer method is used for a cloud server and includes the following steps.

In step 101, the cloud server receives a numerical value transfer request, for example, money transfer request, from a terminal. The numerical value transfer request includes user characteristic information, user account information used on the terminal and a target transfer amount. The user characteristic information is extracted from an image of a user carrying the terminal.

In step 102, the cloud server acquires credit information and historical numerical value transfer record of a user based on the user characteristic information and the user account information.

In step 103, the cloud server processes numerical value transfer based on the credit information, the historical numerical value transfer record and the target transfer amount.

In the embodiment of this disclosure, the terminal extracts the user characteristic information from the target image. Thus, the disclosure saves the user from manually inputting an account number and a password for performing numerical value transfer with easy operations and enhances the security for numerical value transfer. Moreover, in the cloud server, numerical value transfer is performed by acquiring credit information and historical numerical value transfer record of the user and the account related to performing the numerical value transfer is not involved. Thus, the security for numerical value transfer is further improved by the credit degree of the user.

In another embodiment of this disclosure, performing numerical value transfer based on the credit information, the historical numerical value transfer record and the target transfer amount includes determining a credit line of the user based on the credit information and the historical numerical value transfer record, acquiring at least one frequently used address information from a stored corresponding relation between the user account and the frequently used address information based on the user account, sending the at least one frequently used address information to the terminal so that the terminal displays the same, and performing numerical value transfer based on the credit line of the user, a balance of the user account, i.e., a balance of the user account, the transfer amount and a balance of an account in a cloud server when recipient address information selected by the terminal among the at least one frequently used address information is received, the recipient address information being associated with the numerical value transfer being currently performed.

In another embodiment of this disclosure, when the balance of the user account is greater than or equal to the target transfer amount, the target transfer amount is deducted from the balance of the user account, and the deducted transfer amount is added to the balance maintained in the cloud server. When the balance of the user account is less than the target transfer amount, it is determined whether the credit line of the user is greater than the target transfer amount, when the credit line of the user is greater than the target transfer amount, a difference between the balance of the user account and the target transfer amount is calculated. The balance of the user account is deducted, and the deducted balance is added to the balance maintained in the cloud server, and the difference is set as a numerical value to be processed of the user account, and a processing period for the numerical value to be processed is set so that the terminal adds the difference into the user account before the processing period expires.

In another embodiment of this disclosure, user's identity is acquired from a stored corresponding relation between the user characteristic information and the identity based on the user characteristic information. The credit information of the user is acquired based on the user's identity. And, a corresponding historical numerical value transfer record is acquired from a stored corresponding relation between the user account and the historical numerical value transfer record based on the user account.

In another embodiment of this disclosure, it is determined whether a corresponding relation between the user's identity and credit information is stored in the cloud server. If the corresponding credit information is stored, the credit information is acquired based on the corresponding relation. If no corresponding relation is stored, an information acquiring request is sent to a credit information server. The information acquiring request carries the user's identity. Then, credit information is received from the credit information server.

All the above technical solutions may be combined in any form to form an embodiment of this disclosure, which will not be elaborated herein.

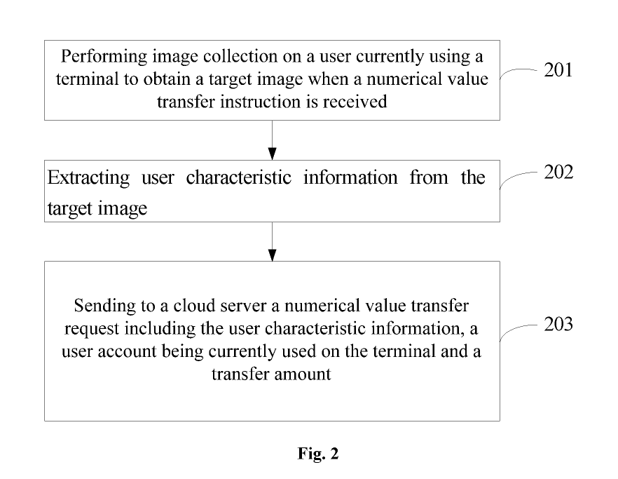

FIG. 2 is a flow chart showing a numerical value transfer method according to an exemplary embodiment. As shown in FIG. 2, the numerical value transfer method is used for a terminal and includes the following steps.

In step 201, when receiving a numerical value transfer instruction, the terminal performs image collection on a user currently using the terminal to obtain a target image. In step 202, user characteristic information is extracted from the target image. In step 203, the terminal sends a numerical value transfer request to a cloud server so that the cloud server performs numerical value transfer based on the numerical value transfer request. The numerical value transfer request carries the user characteristic information, a user account being currently used on the terminal and a target transfer amount.

In the embodiments of this disclosure, when the terminal receives a numerical value transfer instruction, image collection is performed on the user using the terminal to obtain a target image, and by extracting the user characteristic information from the target image, this disclosure saves the user from manually inputting account number and password for performing numerical value transfer with easy operations and the security for numerical value transfer is also enhanced.

In another embodiment of this disclosure, after sending the numerical value transfer request to the cloud server, the terminal receives at least one frequently used address information sent from the cloud server, displays the at least one frequently used address information, determines recipient address information among the at least one frequently used address information, the recipient address information being address information associated with the numerical value transfer, and sends the recipient address information to the cloud server.

In another embodiment of this disclosure, when an instruction for selecting a designated frequently used address information among the at least one frequently used address information is received, the terminal determines the designated frequently used address information as the recipient address information. Alternative, when an instruction for selecting is not received but an address information input instruction is received, the terminal receives address information determined by a designated manner of the user, and determines the recipient address information based on the received address information. The designated manner including voice, remote controller or position locating.

In another embodiment of this disclosure, when an address information modification instruction is received, the terminal receives modified address information obtained after the user modifies the received address information, and sets the modified address information as the recipient address information.

All the above technical solutions may be combined in any form to form an embodiment of this disclosure, which will not be elaborated herein.

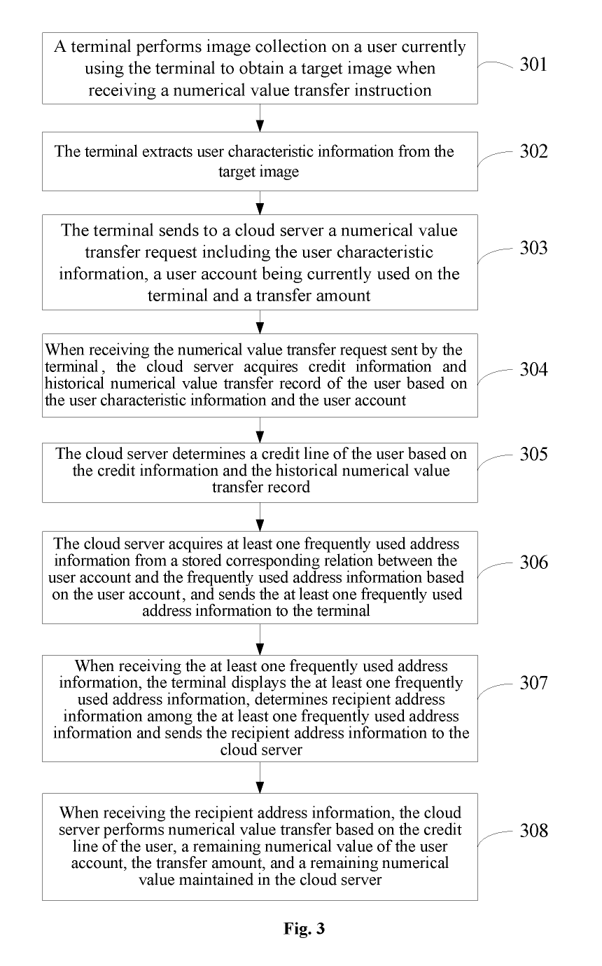

FIG. 3 is a flow chart showing a numerical value transfer method according to an exemplary embodiment. As shown in FIG. 3, the numerical value transfer method may include the following step.

In step 301, when the terminal receives a numerical value transfer instruction, it performs image collection on a user currently using a terminal to obtain a target image.

When the terminal receives a numerical value transfer instruction, the terminal may perform image collection to the user currently using the terminal through an image collection device to obtain a target image. The image collection device may include a camera installed in the terminal, a camera coupled to the terminal, a fingerprint collection device or the like.

In the embodiments of this disclosure, the subject triggering the numerical value transfer instruction may be a user. That is, the user may submit the numerical value transfer instruction to the terminal through a first designation operation which may be, but not limited to, a sliding operation, a voice operation, clicking of a numerical value transfer button or the like.

It should be noted that in the embodiments of this disclosure, the terminal may not only be a smart TV, but also be a computer, a cell phone, a personal access device (PAD), or the like, and it will not be specifically defined in the embodiments of this disclosure.

In step 302, the terminal extracts user characteristic information from the target image. In the embodiments of this disclosure, the target image may be a human face image of the user using the terminal, or an iris image of the user's eyes or a fingerprint image of the user.

When the target image is a human face image of the user, the terminal may perform human face characteristic extraction on the target image to obtain user characteristic information. In this case, the user characteristic information may include, but not limited to, a profile of a human face, or the positions and sizes of the human facial features (the five organs) and the like.

When the target image is an iris image of the user's eyes, the terminal may perform iris characteristic extraction on the target image to obtain user characteristic information. In this case, the user characteristic information may include, but not limited to, a color of the iris, the shape of the iris, the size of the iris and the like.

When the target image is a fingerprint image of the user, the terminal may perform fingerprint characteristic extraction on the target image to obtain user characteristic information. In this case, the user characteristic information may include, but not limited to, a starting point position of the fingerprint, a terminating point position of the fingerprint, an intersection position and the like.

It should be noted that the methods for performing human face characteristic extraction, iris characteristic extraction and fingerprint characteristic extraction on the target image may refer to the related technologies, and will not be elaborated in the embodiments of this disclosure.

In the embodiments of this disclosure, after the terminal obtains the user characteristic information through the above step, numerical value transfer may be performed in the following manner, which saves the user from inputting an account number and a password to the terminal for numerical value transfer with easy operations, so that other users may not easily see the account number and the password, thereby enhancing the security for numerical value transfer, particularly for a smart TV usually placed in the living room.

In step 303, the terminal sends a numerical value transfer request carrying the user characteristic information, a user account being currently logged in to the terminal and a transfer amount of the numerical value transfer request, to a cloud server.

When obtaining the user characteristic information, the terminal may generate a numerical value transfer request based on the user characteristic information, the user account being currently logged in to the terminal and the transfer amount of the numerical value transfer instruction, and sends the numerical value transfer request to the cloud server.

When the terminal generates the numerical value transfer request, the user characteristic information, the user's account number and the target transfer amount may be directly carried by the numerical value transfer request. In another embodiment of this disclosure, the user characteristic information, the user's account number and the target transfer amount may be combined according to a designated manner, and the combined information may be contained in the numerical value transfer request. For example, a character string may be used to associate the user characteristic information, the user's account number and the transfer amount in series. For example, if the character string is designated as #, the user characteristic information as Characteristic 1, the user's account number as 122456, and the target transfer amount as 60, after the terminal combines the user characteristic information, the user's account number and the target transfer amount according to a designated manner, the combined information is obtained as: Characteristic 1#122456#60.

It should be noted that the user account being currently logged in to the terminal is registered in the cloud server. That is, the user account being currently logged in to the terminal may be a communication account.

In step 304, after receiving the numerical value transfer request sent by the terminal, the cloud server acquires credit information and historical numerical value transfer record of the user based on the user characteristic information and the user account.

In order to determine the credit line of the user to improve the security of numerical value transfer, every time a numerical value transfer is performed, the cloud server may record the user account and the numerical value transfer record of the numerical value transfer and store a corresponding relation between the user account and the historical numerical value transfer record. Then, after receiving the numerical value transfer request sent by the terminal, the cloud server may acquire user's identity from the stored corresponding relation between the characteristic information and the user's identity based on the user characteristic information carried by the numerical value transfer request, acquire the credit information of the user based on the user's identity, and acquire the corresponding historical numerical value transfer record from the stored corresponding relation between the user account and the historical numerical value transfer record based on the user account. The historical numerical value transfer record may include a historical transfer amount, the balance of the user account when the historical numerical value transfer is performed, and the like, and will not be specifically defined in the embodiments of this disclosure.

For example, the user characteristic information carried by the numerical value transfer request is characteristic information 1, and the user account is 1654663. After receiving the numerical value transfer request sent by the terminal, the cloud server acquires the user's identity ID1 from the stored corresponding relation between the characteristic information and the user's identity as shown in Table 1 based on the user characteristic information 1 carried by the numerical value transfer request, acquires the user's credit information i.e., credit information 1 based on the user's identity ID1, and acquires the corresponding historical numerical value transfer record i.e., record 1 from the corresponding relation between the user account and the historical numerical value transfer record as shown in Table 2 based on the user account 1654663.

TABLE 1

| Characteristic information | User's Identity |
|---|---|
| Characteristic information 1 | ID1 |
| Characteristic information 2 | ID1 |
| . . . | . . . |

TABLE 2

| | Historical numerical value transfer |
|---|---|
| User account | record |
| 1654663 | Record 1 |
| 1246536 | Record 2 |
| . . . | . . . |

It should be note that, in the embodiments of this disclosure, the numerical values shown in Table 1 and Table 2 are examples only and do not define the embodiments of this disclosure.

Acquiring the credit information of the user based on the user's identity may include the followings. The cloud server searches corresponding credit information from the stored corresponding relation between the user's identity and the credit information based on the user's identity. If the corresponding credit information is retrieved, the cloud server determines the retrieved credit information as the credit information of the user. If no corresponding credit information is searched, the cloud server sends an information acquiring request carrying the user's identity to a credit information server. When the information acquiring request is received by the credit information server, the credit information server acquires the corresponding credit information from the stored corresponding relation between the user's identity and the credit information based on the user's identity, and sends the acquired credit information to the cloud sever. When receiving the credit information sent by the credit information server, the cloud sever determines the received credit information as the credit information of the user.

In the embodiments of this disclosure, when acquiring the credit information of the user from the credit information server for the first time, the cloud sever may store a corresponding relation between the user's identity and the credit information. Thus, when the user performs numerical value transfer afterwards, the cloud sever will not need to acquire the credit information of the user from the credit information server again, which reduces the interaction times between the cloud sever and the credit information server and improves the credit information acquiring efficiency.

Further, the cloud server may periodically acquire the corresponding credit information from the credit information server based on each user's identity in the stored corresponding relation between the user's identity and the credit information with a designated interval to update the stored corresponding relation between the user's identity and the credit information in order to ensure the timeliness and accuracy of the credit information stored in the cloud server. The designated interval may be set in advance and for example may be 3 hours, 1 day or the like, and will not be specifically defined in the embodiments of this disclosure.

It should be noted that the user's identity may be an identification number of the user, and the corresponding relation between the characteristic information and the user's identity may be acquired in advance and stored in the cloud server. In addition, the credit information of the user may include loan information, real estate information, vehicle information, social insurance information, personal income tax information of the user and the like, and will not be specifically defined in the embodiments of this disclosure. The credit information of the user may be used in multiple systems, such as a banking system. Therefore, there are many methods for the cloud server to acquire the credit information of the user based on the user's identity. For example, the cloud server may send an information acquiring request to a server of other system to acquire the credit information of the user from the server of the other system.

In step 305, the cloud server determines a credit line of the user based on the credit information and the historical numerical value transfer record.

The credit information and the historical numerical value transfer record of the user are used to identify the credit line of the user. Therefore, in the embodiments of this disclosure, the cloud server can determine a credit line of the user based on the credit information and the historical numerical value transfer record of the user.

There are many methods for determining a credit line of the user. For example, numerical value conversion may be performed on the credit information to obtain a credit numerical value. Numerical value conversion may be performed on the historical numerical value transfer record to obtain a historical transfer numerical value. Corresponding weights can be set in advance respectively for the credit information and for the historical numerical value transfer record. Then, a first numerical value is obtained by multiplying the credit numerical value with the weight corresponding to the credit information. A second numerical value is obtained by multiplying the historical transfer numerical value with the weight corresponding to the historical numerical value transfer record. The credit line of the user is obtained by adding the first numerical value and the second numerical value. For example, a credit numerical value i.e., 500 is obtained by performing numerical value conversion to the credit information. A historical transfer numerical value i.e., 300 is obtained by performing numerical value conversion to the historical numerical value transfer record. The weight corresponding to the credit information is 0.8 and the weight corresponding to the historical numerical value transfer record is 0.2. At this time, a first numerical value i.e., 400 is obtained by multiplying the credit numerical value 500 with the weight corresponding to the credit information i.e., 0.8. A second numerical value i.e., 60 is obtained by multiplying the historical transfer numerical value i.e., 300 with the weight corresponding to the historical numerical value transfer record i.e. 0.2. A credit line of the user, 460, is obtained by adding the first numerical values i.e., 400 and the second numerical values i.e., 60.

In another example, an average of the credit numerical value and the historical transfer numerical value may be calculated and determined as the credit line of the user. For example, an average of the credit numerical value i.e., 500 and the historical transfer numerical value i.e., 300 may be calculated as 400 and the average, 400, can be determined as the credit score of the user.

In another example, each credit information may be divided into multiple credit levels, and each credit level corresponds to a certain credit numerical value. The historical numerical value transfer record is divided into multiple record levels, and each record level corresponds to a certain record numerical value. A credit level of the acquired credit information and a record level of the acquired historical numerical value transfer record may be determined. A credit numerical value corresponding to the credit level of the acquired credit information and a record numerical value corresponding to the record level of the historical numerical value transfer record may be determined. An average of the credit numerical value and the record numerical value may be calculated and determined as the credit line of the user.

Therefore, the embodiments of this disclosure do not specifically define the methods for determining the credit line, and the related arts may be referred to.

In step 306, the cloud server acquires at least one frequently used address information from a stored corresponding relation between the user account and the frequently used address information based on the user account, and sends the at least one frequently used address information to the terminal.

In the embodiments of this disclosure, when sending the at least one frequently used address information to the terminal, the cloud server may store the at least one frequently used address information into a frequently used address information table and may send the frequently used address information table to the terminal. When receiving the frequently used address information table, the terminal directly displays the same. In another embodiment of this disclosure, the cloud server may also send the at least one frequently used address information to the terminal directly, so that the terminal displays the same in the form of a table. Other manners may be used for displaying, and will not be specifically described in the embodiments of this disclosure.

For example, the at least one frequently used address information includes address information 1, address information 2 and address information 3. The three frequently used address information are stored in the address information table as shown in Table 3 and may send to the terminal.

TABLE 3
Frequently used address information

Address information 1
Address information 2
Address information 3

In step 307, when receiving the at least one frequently used address information, the terminal displays the at least one frequently used address information, determines recipient address information among on the at least one frequently used address information and sends the recipient address information to the cloud server.

In the embodiments of this disclosure, in order to complete the numerical value transfer, it may be necessary to determine the recipient address information. Therefore, when the terminal receives the at least one frequently used address information and displays the same, the user may select a designated address information from the at least one frequently used address information. When receiving an instruction for selecting the designated frequently used address information from the at least one frequently used address information, the terminal determines the designated frequently used address information as the recipient address information. Alternatively, when receiving the at least one frequently used address information, the terminal displays the same, and when not receiving an instruction for selecting the designated frequently used address information from the at least one frequently used address information but receiving an address information input instruction, the terminal may receive address information determined by a designation manner of the user and determine recipient address information based on the received address information. The designation manner may include voice, remote controller or position locating.

Determining the recipient address information based on the received address information may be that the received address information may be determined as the recipient address information directly. In order to ensure the accuracy of the recipient address information, when the terminal receives address information determined by a designation manner of the user, the user may modify the received address information. At this time, the user may submit an address information modification instruction to the terminal. When receiving the address information modification instruction, the terminal receives modified address information obtained after the user modifies the received address information and determines the modified address information as the recipient address information.

For example, when receiving an instruction for selecting address information 2 among the at least one frequently used address information, the terminal determines the address information 2 as the recipient address information. For example, when the terminal does not receive the instruction for selecting but receives an address information input instruction, the terminal may receive address information, for example, address information 6 determined by the designation manner of the user, and when the user modifies the address information 6, the user may submit an address information modification instruction to the terminal. When receiving the address information modification instruction, the terminal receives the modified address information. For example, address information 61 is obtained after the user modifies the address information 6, and the terminal determines the address information 61 as the recipient address information.

In the embodiments of this disclosure, determining the recipient address information based on the at least one frequently used address information may be performed not only through the above two manners, but through other manners. For example, the recipient address information may be determined by determining a use frequency of the at least one frequently used address information and selecting the most frequently used address information and determining the recipient address information based on the selected frequently used address information. Alternatively, frequently used address information the use time of which is the closest to the current time may be selected from the at least one frequently used address information and the recipient address information is determined based on the selected frequently used address information.

When the designation manner is voice, the terminal may receive address information input by voice of the user. When the designation manner is a remote controller, the terminal may receive address information input through a remote controller of the user. When the designation manner is position locating, the terminal may locate its current position to obtain position information of the terminal and determines the position information of the terminal as the received address information.

It should be noted that the address information modification instruction may be submitted by a second designation operation by the user. The second designation operation may be voice operation, pressing of a designated button of a remote controller, swing of a remote controller etc.. The second designation operation will not be specifically described in the embodiments of this disclosure.

In step 308, when receiving the recipient address information sent by the terminal based on the at least one frequently used address information, the cloud server performs numerical value transfer based on the credit line of the user, a balance of the user account, the target transfer amount and a balance maintained in the cloud server.

When receiving the recipient address information sent by the terminal based on the at least one frequently used address information, the cloud server compares the balance of the user account with the target transfer amount. When the balance of the user account is greater than or equal to the target transfer amount, the cloud server deducts the target transfer amount from the balance of the user account and adds the deducted target transfer amount to the balance maintained in the cloud server. When the balance of the user account is less than the target transfer amount, the cloud server determines if the credit line of the user is greater than the transfer amount. When the credit line of the user is greater than the transfer amount, the cloud server calculates a difference between the balance of the user account and the transfer amount, deducts the balance of the user account, and adds the deducted balance to the balance maintained in the cloud server, and sets the difference as a numerical value to be processed for the user account and sets a processing period for the numerical value to be processed so that the terminal adds the difference into the user account before the processing period expires.

For example, if the credit line of the user is 460, the balance of the user account is 200, the transfer amount is 350, and the balance maintained in the cloud server is 1,000, it is determined that the balance of the user account is less than the transfer amount and the credit line of the user is greater than the transfer amount. Then, a difference between the balance 200 of the user account and the transfer amount 350 is calculated as 150. The balance 200 of the user account is deducted, and the deducted balance 200 of the user account is added to the balance 1,000 of the cloud server to obtain 1,200. Then, the numerical value to be processed of the user account is set to be 150, and a processing period of 10 days is set for the numerical value to be processed, so that the terminal adds 150 into the user account within 10 days from the current time.

Further, when the balance of the user account is greater than or equal to the transfer amount, the transfer amount may be deducted from the balance of the user account directly without considering the credit degree of the user. When the balance of the user account is less than the transfer amount, in order to allow the user to complete numerical value transfer, the cloud server needs to pre-pay a part of the numerical value for the user account, and at this time, the credit degree of the user needs to be considered. That is, the credit line of the user and the transfer amount are compared. When the credit line of the user is greater than the transfer amount, the cloud server can complete numerical value transfer as usual, provided that the user needs to add the pre-paid amount of the cloud server into the user account before the processing period expires, i.e., needs to add the difference into the user account. After the user adds the difference into the user account through the terminal before the processing period expires, the cloud server may deduct the difference added to the user account, and add the deducted difference to the balance maintained in the cloud server so as to repay the numerical value pre-paid by the cloud server, thereby facilitating the convenience of numerical value transfer.

In the embodiments of this disclosure, when receiving a numerical value transfer instruction, the terminal performs image collection on the user using the terminal to obtain a target image. By extracting the user characteristic information from the target image, it saves the user from manually inputting an account number and a password for performing numerical value transfer with easy operations and the security for numerical value transfer is also enhanced. Moreover, since the cloud server performs numerical value transfer by acquiring credit information and historical numerical value transfer record of the user, the security for numerical value transfer is further improved. Further, the cloud server may also acquire at least one frequently used address information of the user. If the recipient address information of the numerical value transfer being currently performed is one of the at least one frequently used address information, the user can select the recipient address information from the at least one frequently used address information directly without input again by other manners, thereby enhancing the convenience and improving the efficiency of numerical value transfer.

FIG. 4 is a block diagram of a cloud server according to an exemplary embodiment. As shown in FIG. 4, the cloud server includes a receiving module 401, an acquiring module 402 and a numerical value transfer module 403 as below. A receiving module 401 is configured to receive a numerical value transfer request sent by a terminal. The numerical value transfer request carries user characteristic information, a user account being currently used on the terminal and a target transfer amount. The user characteristic information is extracted from a target image in the terminal. An acquiring module 402 is configured to acquire credit information and historical numerical value transfer record of the user based on the user characteristic information and the user account. A numerical value transfer module 403 is configured to perform numerical value transfer based on the credit information of the user, the historical numerical value transfer record and the transfer amount.

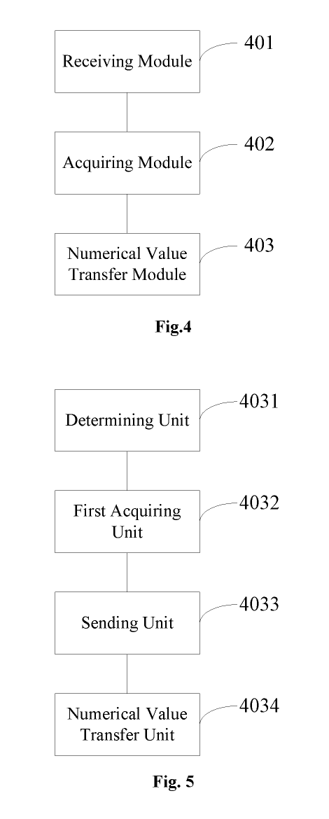

In another embodiment of this disclosure, referring to FIG. 5, the numerical value transfer module 403 includes a determining unit 4031, a first acquire unit 4032, a sending unit 4033, and a numerical value transfer unit 4034. The determining unit 4031 is configured to determine a credit line of the user based on the credit information and the historical numerical value transfer record of the user. The first acquiring unit 4032 is configured to acquire at least one frequently used address information from a stored corresponding relation between the user account and the frequently used address information based on the user account. The sending unit 4033 configured to send the at least one frequently used address information to the terminal so that the terminal displays the same. The numerical value transfer unit 4034 is configured to perform numerical value transfer based on the credit line of the user, a balance of the user account, the target transfer amount and a balance maintained in the cloud server when recipient address information is received from the terminal. The recipient address information is associated with the numerical value transfer.

In another embodiment of this disclosure, the numerical value transfer unit 4034 includes a first deducting subunit configured to, when the balance of the user account is greater than or equal to the transfer amount, deduct the target transfer amount from the balance of the user account, and add the deducted target transfer amount to the balance maintained in the cloud server, a determining subunit configured to, when the balance of the user account is less than the target transfer amount, determine if the credit line of the user is greater than the target transfer amount, a calculating subunit configured to, when the credit line of the user is greater than the target transfer amount, calculate a difference between the balance of the user account and the target transfer amount, a second deducting subunit configured to deduct the balance of the user account and add the deducted balance to the balance maintained in the cloud server, and a setting subunit configured to set the difference as a numerical value to be processed for the user account and set a processing period for the numerical value to be processed so that the terminal adds the difference into the user account before the processing period expires.

In another embodiment of this disclosure, the acquiring module 402 includes a second acquiring unit configured to acquire user's identity from a stored corresponding relation between the characteristic information and the user's identity based on the user characteristic information, a third acquiring unit configured to acquire the credit information of the user based on the user's identity, and a fourth acquiring unit configured to acquire the corresponding historical numerical value transfer record from the stored corresponding relation between the user account and the historical numerical value transfer record based on the user account.

In another embodiment of this disclosure, the third acquiring unit includes a searching subunit configured to search whether a corresponding relation between the user's identity and the credit information is stored, and a first determining subunit configured to, if the corresponding relation is stored, determine the credit information from the corresponding relation as the credit information of the user.

In another embodiment of this disclosure, the third acquiring unit further includes a sending subunit configured to, if no corresponding relation is stored, send an information acquiring request carrying the user's identity to a credit information server, and a second determining subunit configured to, when credit information sent by the credit information server is received, determine the received credit information as the credit information of the user.

In the embodiments of this disclosure, by extracting the user characteristic information from the target image, the terminal saves the user from manually inputting account number and password for performing numerical value transfer with easy operations and enhances the security for numerical value transfer. In addition, since the cloud server performs numerical value transfer by acquiring the credit information and the historical numerical value transfer record of the user, the account related to performing the numerical value transfer is not involved and the security for numerical value transfer is further improved by the credit degree of the user.

With respect to the terminals in the above embodiments, the specific manners for performing operations in individual modules therein have been described in detail in the embodiments regarding the related methods and will not be elaborated herein.

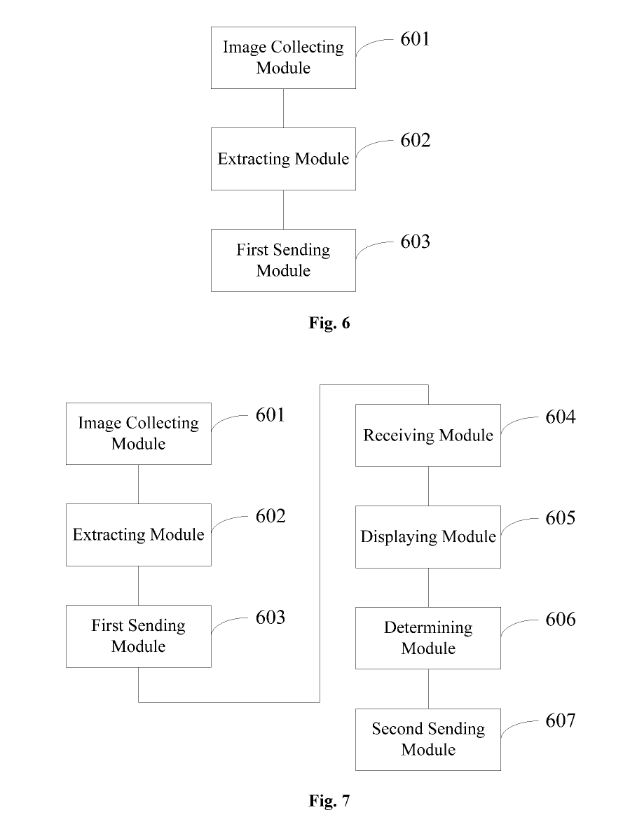

FIG. 6 is a block diagram of a terminal according to an exemplary embodiment. As shown in FIG. 6, the terminal includes an image collecting module 601, an extracting module 602 and a first sending module 603 as below. The image collecting module 601 is configured to, when a numerical value transfer instruction is received, perform image collection on a user currently using the terminal to obtain a target image. The extracting module 602 is configured to extract user characteristic information from the target image. The first sending module 603 is configured to send a numerical value transfer request to a cloud server so that the cloud server performs numerical value transfer based on the numerical value transfer request carrying the user characteristic information, a user account being currently used on the terminal and a target transfer amount.

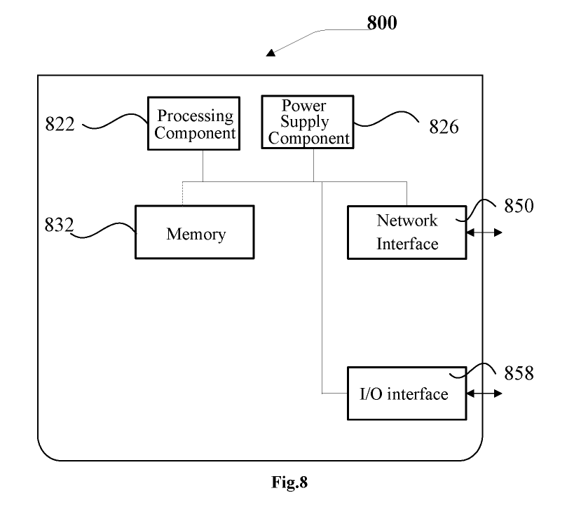

In another embodiment of this disclosure, referring to FIG. 7, the terminal further includes a receiving module 604 configured to receive at least one frequently used address information sent by the cloud server, a displaying module 605 configured to display the at least one frequently used address information, a determining module 606 configured to determine the recipient address information among the at least one frequently used address information, the recipient address information being address information of the numerical value transfer being currently performed, and a second sending module 607 configured to send the recipient address information to the cloud server.

In another embodiment of this disclosure, the determining module 606 includes a first determining subunit configured to, when an instruction for selecting a designated frequently used address information from the at least one frequently used address information is received, determine the designated frequently used address information as the recipient address information, or a second determining subunit configured to, when an instruction for selecting is not received but an address information input instruction is received, receive address information determined by a designation manner of the user, and determine the recipient address information based on the received address information, the designation manner including voice, remote controller or position locating.

In another embodiment of this disclosure, the second determining subunit is specifically configured to when an instruction for selecting is not received but the address information input instruction is received, receive address information determined by a designation manner of the user, when an address information modification instruction is received, receive modified address information obtained after the user modifies the received address information, and determine the modified address information as the recipient address information.

In the embodiments of this disclosure, when receiving a numerical value transfer instruction, the terminal performs image collection on the user currently using the terminal to obtain a target image and by extracting the user characteristic information from the target image, it saves the user from manually inputting account number and password for performing numerical value transfer with easy operations and enhances the security for numerical value transfer.

With respect to the terminals in the above embodiments, the specific manners for performing operations in individual modules therein have been described in detail in the embodiments regarding the related methods and will not be elaborated herein.

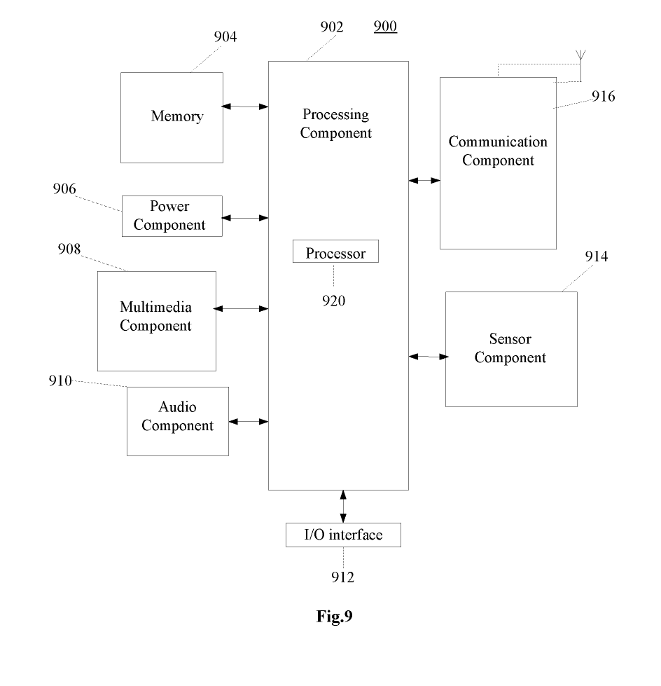

FIG. 8 is a block diagram of a cloud server 800 used for numerical value transfer according to an exemplary embodiment. Referring to FIG. 8, the cloud server 800 includes: a processing component 822 which further includes one or more processors, and memory resources represented by a memory 832 for storing instructions executable by the processing component 822, such as applications. The applications stored in the memory 832 may include one or more modules each of which corresponding to a group of instructions. In addition, the processing component 822 is configured to execute instructions to execute the following numerical value transfer method, including receiving a numerical value transfer request sent by a terminal, the numerical value transfer request carrying user characteristic information, a user account being currently used on the terminal and a target transfer amount, the user characteristic information being extracted from a target image in the terminal, acquiring credit information and historical numerical value transfer record of a user based on the user characteristic information and the user account, and performing numerical value transfer based on the credit information, the historical numerical value transfer record and the target transfer amount.

In another embodiment of this disclosure, performing numerical value transfer based on the credit information, the historical numerical value transfer record and the target transfer amount includes determining a credit line of the user based on the credit information and the historical numerical value transfer record, acquiring at least one frequently used address information from a stored corresponding relation between the user account and the frequently used address information based on the user account, sending the at least one frequently used address information to the terminal so that the terminal displays the same, and performing numerical value transfer based on the credit line of the user, a balance of the user account, the target transfer amount and a balance of a cloud server when recipient address information is received from terminal among the at least one frequently used address information, the recipient address information being associated with the numerical value transfer.

In another embodiment of this disclosure, performing numerical value transfer based on the credit line of the user, the balance of the user account, the target transfer amount and the balance maintained in the cloud server includes when the balance of the user account is greater than or equal to the target transfer amount, deducting the target transfer amount from the balance of the user account, and adding the deducted target transfer amount to the balance maintained in the cloud server, when the balance of the user account is less than the target transfer amount, determining if the credit line of the user is greater than the target transfer amount, when the credit line of the user is greater than the target transfer amount, calculating a difference between the balance of the user account and the target transfer amount, deducting the balance of the user account, and adding the deducted balance to the balance maintained in the cloud server, and setting the difference as a numerical value to be processed of the user account, and setting a processing period for the numerical value to be processed so that the terminal adds the difference into the user account before the processing period expires.

In another embodiment of this disclosure, acquiring credit information and historical numerical value transfer record of a user based on the user characteristic information and the user account includes acquiring user's identity from a stored corresponding relation between the characteristic information and the user's identity based on the user characteristic information, acquiring the credit information of the user based on the user's identity, and acquiring the corresponding historical numerical value transfer record from the stored corresponding relation between the user account and the historical numerical value transfer record based on the user account.

In another embodiment of this disclosure, acquiring the credit information of the user based on the user's identity includes searching for a corresponding relation between the user's identity and the credit information, and if the corresponding relation is retrieved, determining the credit information based on the user's identity.

In another embodiment of this disclosure, after searching for the corresponding relation between the user's identity and the credit information based on the user's identity, the method further includes if no corresponding relation is retrieved, sending an information acquiring request carrying the user's identity to a credit information server, and when credit information sent by the credit information server is received, determining the received credit information as the credit information of the user.

The cloud server 800 may further include a power supply component 826 configured to perform power supply management of the cloud server 800, a wired or wireless network interface 850 configured to connect the cloud server 800 to a network, and an input and output (I/O) interface 858. The cloud server 800 may be operated based on an operating system stored in the memory 832, such as Windows Server™, Mac OS X™, Unix™, Linux™, FreeBSD™ or the like.

FIG. 9 is a block diagram of a terminal 900 used for numerical value transfer according to an exemplary embodiment. For example, the terminal 900 may be a mobile phone, a computer, a digital broadcast terminal, a messaging device, a gaming console, a tablet, a medical device, a fitness equipment, a personal digital assistant or the like.

Referring to FIG. 9, the terminal 900 may include one or more of the following components: a processing component 902, a memory 904, a power supply component 906, a multimedia component 908, an audio component 910, an input/output (I/O) interface 912, a sensor component 914, and a communication component 916.

The processing component 902 typically controls overall operations of the terminal 900, such as the operations associated with display, telephone calls, data communications, camera operations, and recording operations. The processing component 902 may include one or more processors 920 to execute instructions to perform all or part of the steps in the above described methods. Moreover, the processing component 902 may include one or more modules which facilitate the interaction between the processing component 902 and other components. For instance, the processing component 902 may include a multimedia module to facilitate the interaction between the multimedia component 908 and the processing component 902.

The memory 904 is configured to store various types of data to support the operation of the terminal 900. Examples of such data include instructions for any applications or methods operated on the terminal 900, contact data, phonebook data, messages, pictures, video, etc. The memory 904 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 906 provides power to various components of the terminal 900. The power component 906 may include a power supply management system, one or more power sources, and any other components associated with the generation, management, and distribution of power in the terminal 900.

The multimedia component 908 includes a screen providing an output interface between the terminal 900 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 908 includes a front camera and/or a rear camera. The front camera and/or the rear camera may receive an external multimedia datum while the terminal 900 is in an operation mode, such as a photographing mode or a video mode. Each of the front camera and the rear camera may be a fixed optical lens system or have focus and optical zoom capability.

The audio component 910 is configured to output and/or input audio signals. For example, the audio component 910 includes a microphone (MIC) configured to receive an external audio signal when the terminal 900 is in an operation mode, such as a call mode, a recording mode, and a voice recognition mode. The received audio signal may be further stored in the memory 904 or transmitted via the communication component 916. In some embodiments, the audio component 910 further includes a speaker to output audio signals.

The I/O interface 912 provides an interface between the processing component 902 and peripheral interface modules, such as a keyboard, a click wheel, buttons, and the like. The buttons may include, but are not limited to, a home button, a volume button, a starting button, and a locking button.

The sensor component 914 includes one or more sensors to provide status assessments of various aspects of the terminal 900. For instance, the sensor component 914 may detect an open/closed status of the terminal 900, relative positioning of components, e.g., the display and the keypad, of the terminal 900, a change in position of the terminal 900 or a component of the terminal 900, a presence or absence of user contact with the terminal 900, an orientation or an acceleration/deceleration of the terminal 900, and a change in temperature of the terminal 900. The sensor component 914 may include a proximity sensor configured to detect the presence of nearby objects without any physical contact. The sensor component 914 may also include a light sensor, such as a CMOS or CCD image sensor, for use in imaging applications. In some embodiments, the sensor component 914 may also include an accelerometer sensor, a gyroscope sensor, a magnetic sensor, a pressure sensor, or a temperature sensor.

The communication component 916 is configured to facilitate communication, wired or wirelessly, between the terminal 900 and other devices. The terminal 900 can access a wireless network based on a communication standard, such as WiFi, 2G, or 3G, or a combination thereof. In one exemplary embodiment, the communication component 916 receives a broadcast signal or broadcast associated information from an external broadcast management system via a broadcast channel. In one exemplary embodiment, the communication component 916 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the terminal 900 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

Each module discussed above, such as the receiving module 401, the acquiring module 402 and the numerical value transfer module 403, may take the form of a packaged functional hardware unit designed for use with other components, a portion of a program code (e.g., software or firmware) executable by the processor or the processing circuitry that usually performs a particular function of related functions, or a self-contained hardware or software component that interfaces with a larger system, for example.

In exemplary embodiments, there is also provided a non-transitory computer-readable storage medium including instructions, such as included in the memory 904, executable by the processor 920 in the terminal 900, for performing the above-described methods. For example, the non-transitory computer-readable storage medium may be a ROM, a RAM, a CD-ROM, a magnetic tape, a floppy disc, an optical data storage device, and the like.

When an instruction stored in the storage medium is executed by a processor of a terminal, the terminal is capable of executing a numerical value transfer method. The method includes when a numerical value transfer instruction is received, performing image collection on a user currently using the terminal to obtain a target image, extracting user characteristic information from the target image, and sending a numerical value transfer request to a cloud server so that the cloud server performs numerical value transfer based on the numerical value transfer request carrying the user characteristic information, a user account used on the terminal and a target transfer amount.

In another embodiment of this disclosure, after sending the numerical value transfer request to a cloud server, the method further includes receiving at least one frequently used address information sent from the cloud server, displaying the at least one frequently used address information, determining recipient address information among the at least one frequently used address information, the recipient address information being associated with the numerical value transfer being currently performed, and sending the recipient address information to the cloud server.

In another embodiment of this disclosure, determining the recipient address information among the at least one frequently used address information includes when an instruction for selecting a designated frequently used address information among the at least one frequently used address information is received, determining the designated frequently used address information as the recipient address information. Alternatively, determining the recipient address information includes when an instruction for selecting is not received but an address information input instruction is received, receiving address information determined by a designation manner of the user, and determining the recipient address information based on the received address information, the designation manner including voice, remote controller or position locating.

In another embodiment of this disclosure, determining the recipient address information based on the received address information includes when an address information modification instruction is received, receiving modified address information obtained after the user modifies the received address information, and determining the modified address information as the recipient address information.

In the embodiments of this disclosure, when receiving a numerical value transfer instruction, the terminal performs image collection on the user currently using the terminal to obtain a target image, and by extracting the user characteristic information from the target image, it saves the user from manually inputting account number and password for performing numerical value transfer with easy operations and enhances the security for numerical value transfer.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for processing a monetary value transfer, comprising:
receiving, by a cloud server, a monetary value transfer request from a terminal, the monetary value transfer request including user characteristic information, a user account being currently used on the terminal and a transfer amount, the user characteristic information being extracted from a target image obtained by the terminal;
acquiring, by the cloud server, credit information and historical monetary value transfer record of a user of the terminal based on the user characteristic information and the user account; and
processing, by the cloud server, the monetary value transfer based on the credit information, the historical monetary value transfer record and the transfer amount.

2. The method according to claim 1, wherein performing monetary value transfer based on the credit information, the historical monetary value transfer record and the transfer amount comprises:
determining a credit line of the user based on the credit information and the historical monetary value transfer record;
acquiring at least one frequently used address information for the user from a corresponding relation between the user account and the frequently used address information based on the user account, the corresponding relation being stored in the cloud server;
sending the at least one frequently used address information to the terminal so that the terminal displays the at least one frequently used address information; and
performing monetary value transfer based on the credit line, a balance of the user account, the transfer amount and a balance of a cloud server when selected recipient address information is received from the terminal , the selected recipient address information being address information related to the monetary value transfer.

3. The method according to claim 2, wherein performing monetary value transfer based on the credit line, the balance of the user account, the transfer amount and the balance of the cloud server comprises:
when the balance of the user account is greater than or equal to the transfer amount, deducting the transfer amount from the balance of the user account, and adding the deducted transfer amount to the balance of the cloud server;
when the balance of the user account is less than the transfer amount, determining whether the credit line is greater than the transfer amount;
when the credit line is greater than the transfer amount, calculating a difference between the balance of the user account and the transfer amount;
deducting the balance of the user account, and adding the deducted balance to the balance of the cloud server; and
setting a monetary value to be processed for the user account as the difference, and setting a processing period for the monetary value to be processed.

4. The method according to claim 1, wherein acquiring credit information and historical monetary value transfer record of a user based on the user characteristic information and the user account comprises:
acquiring user's identity from a stored corresponding relation between the user characteristic information and the user's identity based on the user characteristic information;
acquiring the credit information of the user based on the user's identity; and
acquiring the corresponding historical monetary value transfer record from a stored corresponding relation between the user account and the historical monetary value transfer record based on the user account.

5. The method according to claim 4, wherein acquiring the credit information of the user based on the user's identity comprises:
determining whether a corresponding relation between the user's identity and the credit information is stored in the cloud server; and
acquiring the credit information of the user from the corresponding relation when the corresponding relation is stored in the cloud server.

6. The method according to claim 5, wherein acquiring the credit information of the user based on the user's identity further comprises:
sending an information acquiring request carrying the user's identity to a credit information server when the corresponding relation is not stored in the cloud server; and
receiving credit information for the user from the credit information server.

7. The method according to claim 1, wherein the target image is captured by a camera of the terminal.

8. The method according to claim 1, wherein the target image comprises at least one of a face image of the user, an iris image of the user, or a fingerprint image of the user.

9. The method according to claim 1, further comprising:
sending, by the cloud server, a message related to the monetary value transfer to a terminal of a recipient.

10. A cloud server, comprising:
a processor; and
a memory configured to store an instruction executable by the processor,
wherein the processor is configured to:
receive a monetary value transfer request from a terminal, the monetary value transfer request including user characteristic information, a user account used on the terminal and a transfer amount, the user characteristic information being extracted from a user image collected by the terminal;
acquire credit information and historical monetary value transfer record of the user based on the user characteristic information and the user account; and
process monetary value transfer based on the credit information, the historical monetary value transfer record and the transfer amount.

11. The cloud server according to claim 10, wherein the processor is configured to:
determine a credit line of the user based on the credit information and the historical monetary value transfer record;
acquire at least one frequently used address information from a relation between the user account and the frequently used address stored in the memory;
send the at least one frequently used address information to the terminal; and
perform monetary value transfer based on the credit line, a balance of the user account, the transfer amount and a balance of a cloud server when selected recipient address information is received from the terminal, the recipient address information being address information related to the monetary value transfer.

12. The cloud server according to claim 11, wherein the processor is configured to:
when the balance of the user account is greater than or equal to the transfer amount, deduct the transfer amount from the balance of the user account, and add the deducted transfer amount to the balance of the cloud server;
when the balance of the user account is less than the transfer amount, determine whether the credit line is greater than the transfer amount;
when the credit line is greater than the transfer amount, calculate a difference between the balance of the user account and the transfer amount;
deduct the balance of the user account, and add the deducted balance to the balance of the cloud server; and
set a monetary value to be processed for the user account as the difference, and set a processing period for the monetary value to be processed.

13. The cloud server according to claim 10, wherein the processor is configured to:
acquire user's identity from a stored corresponding relation between the user characteristic information and the user's identity based on the user characteristic information;
acquire the credit information of the user based on the user's identity; and
acquire the corresponding historical monetary value transfer record from a stored corresponding relation between the user account and the historical monetary value transfer record based on the user account.

14. The cloud server according to claim 13, wherein the processor is configured to:
determine whether a corresponding relation between the user's identity and the credit information is stored in the cloud server; and
acquire the credit information of the user from the corresponding relation when the corresponding relation is stored in the cloud server.

15. The cloud server according to claim 14, wherein the processor is configured to:
send an information acquiring request carrying the user's identity to a credit information server when the corresponding relation is not stored in the cloud server; and
receiving credit information for the user from the credit information server.

16. A terminal, comprising:
a processor; and
a memory configured to store an instruction executable by the processor,
wherein the processor is configured to:
obtain an image of a user currently using the terminal when a monetary value transfer instruction is received;
extract user characteristic information from the image of the user; and
send a monetary value transfer request to a cloud server, the monetary value transfer request including the user characteristic information, a user account being used on the terminal and a transfer amount.
